(19) United States
(12) Patent Application Publication
(10) Pub. No.: US 2005/0286121 A1
(43) Pub. Date: Dec. 29, 2005

(54) Objective, especially a projection objective for microlithography

(75) Inventors: Ulrich Weber, Ulm (DE); Hubert Holderer, Oberkochen (DE); Alexander Kohl, Aalen (DE)

Correspondence Address: WELSH & KATZ, LTD, 120 S RIVERSIDE PLAZA, 22ND FLOOR, CHICAGO, IL, 60606, US

(73) Assignee: Carl Zeiss SMT AG, Oberkochen (DE)

(21) Appl. No.: 10/517,265

(22) PCT Filed: May 7, 2003
(86) PCT No.: PCT/EP03/04772

§ 371 Date: Aug. 1, 2005

(30) Foreign Application Priority Data
Jun. 7, 2002 (DE) 102 25 265.3

(51) Int. Cl. G02B 23/24

(52) U.S. Cl. 359/362

(57) ABSTRACT

An objective is provided with a plurality of lenses, mirrors and at least one beam splitter element (20) inserted in an objective housing (1). One or more surfaces (26, 27, 28), situated in the beam path, of the beam splitter element (20) are provided as correction aspherics. The beam splitter element (20) can be provided with manipulators (22) that are arranged on a manipulator carrier (23) which is permanently connected to the objective housing.

The invention relates to an objective having a plurality of lenses, mirrors and at least one beam splitter element inserted in an objective housing. In particular, the invention relates to a projection objective for microlithography for producing semiconductor components.

Use is increasingly being made of so-called correction aspherics in order to correct optical elements, in particular objectives for the semiconductor industry such as, for example, projection objectives for producing semiconductor elements. Thus, for example, it is known to use a correction aspheric near the object or an image field region of the objective, and a correction aspheric near a pupil region. Aberrations in the imaging accuracy, for example aberrations lying outside prescribed tolerances, can be corrected subsequently by means of the correction aspherics. For this purpose, lenses selected correspondingly therefor are removed from the objective, their surfaces to be aspherized are machined appropriately to yield a new desired and/or preselected aspheric as correction aspheric in order to correct the aberrations in the imaging accuracy. The lens thus machined with the correction aspheric is subsequently reinserted into the objective housing. However, a precondition for this is that, after the reinstallation, the machined optical element is seated again exactly within its six degrees of freedom at the same point as before being removed. Moreover, the removal and installation is to be as simple as possible and also after it is reinstalled there must be the same deformation state of the machined element as was present before its removal.

If a plurality of correction aspherics are required in the objective, this entails a corresponding outlay.

### SUMMARY OF THE INVENTION

The object of the present invention is therefore to provide correction aspherics in the objective which entail a low outlay, there being, in particular, a simplification in their removal and subsequent installation.

According to the invention, this object is achieved by virtue of the fact that one or more surfaces, situated in the beam path, of the beam splitter element are provided as correction aspherics, the beam splitter element advantageously being connected to manipulators that are arranged on a manipulator carrier which is permanently connected to the objective housing.

According to the invention, use is now made of a beam splitter element to form correction aspherics.

A beam splitter element is to be installed exactly in an objective with reference to its position. If it is now also provided with manipulators, it can be removed and reinstalled with reference to its position in a specifically repeatable fashion. It is also simultaneously possible to maintain the deformation state in this case. If required, three transmitting surfaces are available as correction aspherics owing to the fact that a beam splitter element, for example a beam splitter cube, has a plurality of surfaces situated in the beam path, specifically the entry surface of the beam splitter element, an intermediate exit surface situated offset in relation thereto by an angle of 90° ±20° , and a rear exit surface, as seen in the beam direction. This means that, by comparison with the known correction aspherics fitted on lenses, there is a need to remove only a single part, specifically the beam splitter element, after which it is possible to machine three different transmitting surfaces in case of need, and thus to undertake three different corrections.

All that need be ensured in this case is that the beam splitter element is provided with manipulators and sensors in such a way that exactly the same position as obtained before removal can be recreated after the removal and completed reinstallation so as to prevent new aberrations being introduced into the objective.

In general, it will be sufficient to provide a possibility of pivoting the beam splitter element about at least two axes that are advantageously located in the beam splitter plane.

In this case, the tilt axes should intersect at a point, the aim being, in an advantageous embodiment of the invention, for the point of intersection to be situated in the beam splitter plane in a central region in which the principle axis lies.

As a result of such an embodiment, no spatial displacements occur. That is to say, it is also possible, if required, to design the manipulators such that the beam splitter element can be tilted about three axes, one of the tilt axes lying in the beam splitter plane, and the two other tilt axes each lying, offset by 90° in relation thereto, at an angle of 45° to the beam splitter plane.

Advantageous refinements and developments emerge from the exemplary embodiment described in principle below with the aid of the drawing, in which:

### BRIEF DESCRIPTION OF THE DRAWINGS

FIG. 1 shows an illustration of the principle of a projection exposure machine having a projection objective with a beam splitter cube according to the invention as beam splitter element,

FIG. 2 shows an enlarged illustration of the beam splitter cube from FIG. 1, in side view, and

FIG. 3 shows a view of the beam splitter element from the direction of the arrow A in accordance with FIG. 2.

### DETAILED DESCRIPTION OF ONE EMBODIMENT OF THE INVENTION

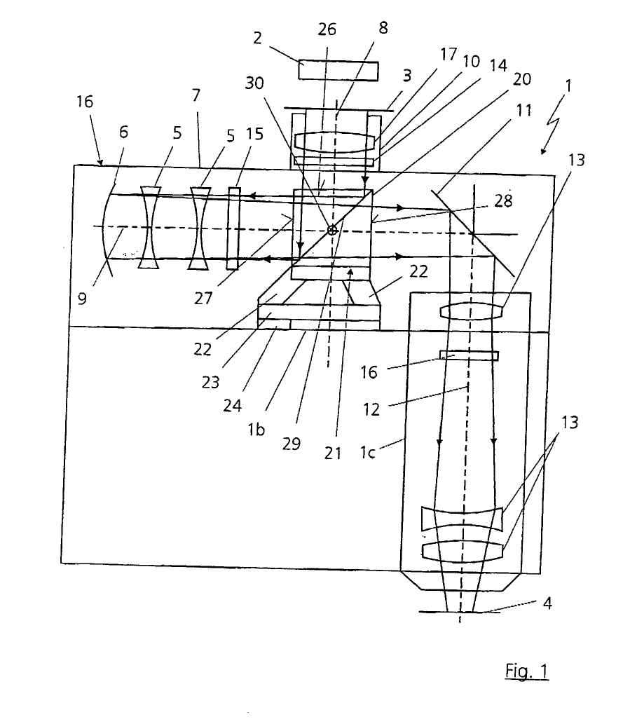

FIG. 1 illustrates the principle of a projection exposure machine having a projection objective 1 for microlithography, for the purpose of producing semi-conductor elements.

Said objective has an illuminating system 2 with a laser (not illustrated) as a light source. Located in the object plane of the projection exposure machine is a reticle 3 whose structure is to be imaged on a correspondingly reduced scale onto a wafer 4 that is arranged below the projection objective 1 and is located in the image plane.

The projection objective 1 is provided with a first, vertical objective part 1a and a second, horizontal objective part 1b. Located in the objective part 1b are a plurality of lenses 5 and a concave mirror 6, which are arranged in an objective housing 7 of the objective part 1b. A beam splitter element 20 is provided in order to deflect the projection beam (see arrow) from the vertical objective part 1a with a vertical optical axis 8 into the horizontal objective part 1b with a horizontal optical axis 9.

After reflection of the beams at the concave mirror 6 and subsequent passage through the beam splitter element 20, these strike a deflecting mirror 11. At the deflecting mirror 11, the horizontal beam path 9 is deflected in turn to a vertical optical axis 12. Located below the deflecting mirror 11 is a third, vertical objective part 1c with a further lens group 13. Also additionally located in the beam path are three λ/4 plates 14, 15 and 16. The λ/4 plate 14 is located in the projection objective 1 between the reticle 3 and the beam splitter element 20 downstream of a lens or lens group 17, and in each case varies the direction of polarization of the beams by 90° . The λ/4 plate 15 is located in the beam path of the horizontal objective part 1b, and the λ/4 plate 16 is located in the third objective part 1c. The three λ/4 plates serve the purpose of changing the polarization during passage through the projection objective 1 such that the same direction of polarization again obtains on the output side as on the input side, as a result of which, inter alia, beam losses are minimized.

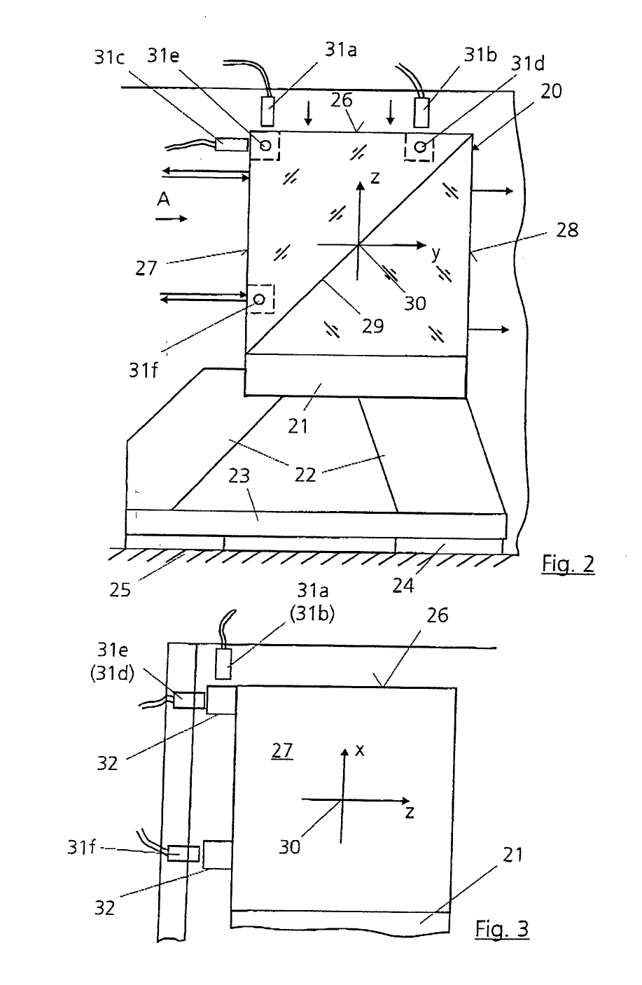

The beam splitter element 20 from FIG. 1 is explained in more detail in an enlarged illustration in FIGS. 2 and 3. The beam splitter element 20 is arranged on an intermediate support 21 for the purpose of deformation decoupling. Manipulators 22 (not illustrated in more detail) act on the intermediate support 21 and are supported on a manipulator carrier 23. The manipulator carrier 23 is connected to a part of the objective housing 1b of the projection objective via tuning disks 24 that serve to adjust the beam splitter element 20 for the first time.

The beam splitter element 20 has 3 optically active surfaces that are situated in the beam path. These are an entry surface 26, which is situated in the beam path between the lens 17 and the beam splitter element 20, an intermediate exit surface 27, which is situated in the beam path of the horizontal objective part 1b of the projection objective 1 with the lenses 5 together with the deflecting mirror 6 and λ/4 plates 15, and an exit surface 28 of the beam splitter element that is directed toward the deflecting mirror 11.

In a well known manner, the effect of the beam splitter element 20 in conjunction with the λ/4 plates 14 and 15 is a deflection into the horizontal objective part 1b comprising the mirror 6 and the lenses 5 of the projection objective 1. This detection takes place at the beam splitter plane 29 being inclined by 45° ±10° to the incident beam path, of the beam splitter element 20 owing to the λ/4 plate 15 located in this beam path, the beam path reflected by the mirror 6 now penetrates the beam splitter plane 29 and exits at the exit surface 28 of the beam splitter element 20.

This means that three surfaces are available for forming correction aspherics at the beam splitter element 20, specifically the entry surface 26, the intermediate exit surface 27 and the exit surface 28.

If, after installation of all the optical elements in the projection objective 1, it is established that corrections are required to increase the imaging accuracy, the beam splitter element 20 is removed and, in accordance with the correction requirements, individual surfaces, or all three of the available surfaces situated in the beam path, are correspondingly provided with correction aspherics. This is followed by renewed installation.

In order, now, to carry out this renewed installation as exactly as possible and to reinstall the beam splitter element 20 with appropriate accuracy in the position that it had, the manipulators 22 must be designed and moved appropriately. At the same time, this means that it must be possible to pivot the beam splitter element 20 at least about two axes. The two axes are the x- and y-axes, the x-axis being located in the beam splitter plane 29, and the y-axis being inclined at 45° thereto, as a result of which it is also situated at the same time parallel to the optical axis in the exit region.

In addition, for adjusting purposes, it is also possible, to be precise, to include the z-axis as a third tilt axis that is situated offset by 90° in relation to the two other axes and at an angle of 45° to the beam splitter plane 29, as a result of which it is also situated parallel to the optical axis in the entry region.

In this case, the three tilt axes, the x-, y- and z-axes, are to intersect at a point that is located in the beam splitter plane 29 in the central region, in which the principal axis also lies. This point is denoted by “30” in FIGS. 2 and 3.

Sensors and reference surfaces are correspondingly required for the purpose of adjusting the beam splitter element 20. As is illustrated in FIGS. 2 and 3, these can be capacitive sensors 31a, 31b, 31c, 31d, 31e and 31f. The sensors “31a to 31f ” cooperate in a known way with reference surfaces 32 that are located on the beam splitter element 20. The capacitive sensors 31a and 31b are situated without making contact at a spacing from one another upstream of the entry surface 26. The sensor 31c is located without making contact upstream of the intermediate exit surface 27, and the sensors 31d, e and f are situated on one side of the beam splitter element 26, being situated parallel to the horizontally running beam path and at right angles both to the entry surface 26 and to the intermediate exit surface 27 and the exit surface 28.

The manipulators 22 can be of any desired design. The only important point is that they be designed such that the beam splitter element 20 can be tilted about at least two, preferably three, tilt axes. Thus, for example, the intermediate support 21 can be connected by a universal joint via the manipulators 22 to the manipulator carrier 23. The articulated joints for this purpose can be designed as solid joints, since these make possible displacements that are very exact and reproducible.

1-9. (canceled)

10. An objective comprising a plurality of lenses, mirrors and at least one beam splitter element inserted in an objective housing, wherein one or more surfaces located in the beam path, of said beam splitter element are provided as correction aspherics.

11. The objective as claimed in claim 10, wherein said beam splitter element is connected to manipulators that are arranged on a manipulator carrier which is permanently connected to the objective housing.

12. The objective as claimed in claim 10, wherein provided as correction aspherics are an entry surface of said beam splitter element, an intermediate exit surface of said beam splitter element, located offset in relation to said entry surface, and a rear exit surface, as seen in the beam direction, of said beam splitter element.

13. The objective as claimed in claim 12, wherein said beam splitter element can be tilted about at least two axes.

14. The objective as claimed in claim 13, wherein the tilt axes intersect at a point.

15. The objective as claimed in claim 14, wherein said point of intersection is located in the beam splitting plane of said beam splitter element in a central region in which the principal axis is located.

16. The objective as claimed in claim 13, wherein said beam splitter element is tiltable about three axes, one of the tilt axes being located in the beam splitting plane, and the two other tilt axes each being located, offset by 90° in relation thereto, at an angle of 45° to the beam splitting plane.

17. The objective as claimed in claim 11, wherein for the purpose of deformation decoupling of said beam splitter element an intermediate support on which said beam splitter element is arranged and on which said manipulators act, is provided.

18. The objective as claimed in one of claims 10 to 17, wherein it is a projection objective for microlithography for producing semiconductor components.

19. An objective comprising a plurality of optical elements inserted in an objective housing, and at least one beam splitter element, wherein said beam splitter element is provided with manipulators, and wherein one or more surfaces, located in the beam path, of said beam splitter element are provided for processing as correction aspherics.

20. The objective as claimed in claim 19, wherein said manipulators are arranged on a manipulator carrier which is permanently connected to the objective housing.

21. The objective as claimed in claim 19, wherein provided as correction aspherics are an entry surface of said beam splitter element, an intermediate exit surface of said beam splitter element, situated offset in relation to said entry surface, and a rear exit surface, as seen in the beam direction of said beam splitter element.

22. The objective as claimed in claim 21, wherein said beam splitter element is tiltable by said manipulators about at least two axes (x,y).

23. The objective as claimed in claim 22, wherein the tilt axes intersect at a point.

24. The objective as claimed in claim 23, wherein said point of intersection is located in the beam splitting plane of said beam splitter element in a central region in which the principal axis is located.

25. The objective as claimed in claim 22, wherein said beam splitter element is tiltable by said manipulators about three axes, one of the tilt axes (x) being located in the beam splitting plane, and the two other tilt axes each being located, offset by 90° in relation thereto, at an angle of 45° to the beam splitting plane.

26. The objective as claimed in claim 20, wherein provided for the purpose of deformation decoupling of said beam splitter element is an intermediate support on which said beam splitter element is arranged and on which said manipulators act.

27. A projection objective for microlithography for producing semiconductor components, comprising optical elements inserted in an objective housing, and at least one beam splitter element, wherein said beam splitter element is provided with manipulators, and wherein one or more surfaces, located in the beam path, of said beam splitter element are provided for processing as correction aspherics.

28. The projection objective as claimed in claim 27, wherein said manipulators are arranged on a manipulator carrier which is permanently connected to the objective housing.

29. The projection objective as claimed in claim 27, wherein provided as correction aspherics are an entry surface of said beam splitter element, an intermediate exit surface of said beam splitter element, located offset in relation to said entry surface, and a rear exit surface, seen in the beam direction of said beam splitter element.

30. The projection objective as claimed in claim 29, wherein said beam splitter element is tiltable by said manipulators about at least two axes (x,y).

31. The projection objective as claimed in claim 30, wherein the tilt axes (y,x,z) intersect at a point.

32. The projection objective as claimed in claim 31, wherein said point of intersection is located in the beam splitting plane of said beam splitter element in a central region in which the principal axis is located.

33. The projection objective as claimed in claim 30, wherein said beam splitter element is tiltable by said manipulators about three axes, one of the tilt axes (x) being located in the beam splitting plane, and the two other tilt axes (y, z) each being located, offset by 90° in relation thereto, at an angle of 45° to the beam splitting plane.

34. The projection objective as claimed in claim 27, wherein provided for the purpose of deformation decoupling of said beam splitter element is an intermediate support on which said beam splitter element is arranged and on which said manipulators act.

35. A system for correcting imaging aberrations in a projection objective for microlithography for producing semiconductor components, comprising a plurality of optical elements inserted in an objective housing, and comprising at least one beam splitter element, one or more surfaces, located in the beam path, of said beam splitter element being used as correction aspherics in such a way that if imaging aberrations are found said beam splitter element is removed, said one or more surfaces located in the beam path are processed, and said beam splitter element is subsequently reinstalled.

36. The system as claimed in claim 35, wherein said at least one beam splitter element is provided with manipulators that align said beam splitter element in the objective housing.

37. The system as claimed in claim 35, wherein the imaging accuracy of a projection beam is measured, and one or more surfaces located in the beam path are corrected by using the measurement result in the state with the objective housing removed, and said beam splitter element is subsequently reinstalled in the objective housing.

38. The system as claimed in claim 37, wherein the correction method of said surfaces is carried out in a number of steps.

39. The system as claimed in claim 35, wherein used as correction aspherics are an entry surface of said beam splitter element, an intermediate exit surface of said beam splitter element, situated offset in relation to said entry surface, and a rear exit surface, as seen in the beam direction of said beam splitter element.

40. The system as claimed in claim 36, wherein said beam splitter element is tilted by said manipulators about at least two axes (x,y).

41. The system as claimed in claim 40, wherein the tilt axes (y,x,z) intersect at a point.

42. The system as claimed in claim 41, wherein said point of intersection is located in the beam splitting plane of said beam splitter element in a central region in which the principal axis is located.

43. The system as claimed in claim 40, wherein said beam splitter element can be tilted by said manipulators about three axes, one of the tilt axes (x) being located in the beam splitting plane, and the two other tilt axes (y, z) each being located, offset by 90° in relation thereto, at an angle of 45° to the beam splitting plane.

44. The system as claimed in claim 35, wherein provided for the purpose of deformation decoupling of said beam splitter element is an intermediate support on which said beam splitter element is arranged and on which said manipulators act.
